(19) United States
(12) Patent Application Publication
(10) Pub. No.: US 2011/0088294 A1
(43) Pub. Date: Apr. 21, 2011

(54) GREETING CARD AND GREETING CARD DISPLAY FRAME ARRANGEMENTS

(76) Inventor: Bridget Teresa Docking, Pontypool (GB)

(21) Appl. No.: 12/993,052

(22) PCT Filed: Jun. 26, 2009
(86) PCT No.: PCT/GB2009/001613

§ 371 Date: Nov. 16, 2010

(30) Foreign Application Priority Data
Jul. 1, 2008 (GB) 0812011.5
Feb. 20, 2009 (GB) 0902922.4
Apr. 30, 2009 (GB) 0907470.9

(51) Int. Cl. G09F 1/12; G09F 1/04; B42D 15/04; G09F 1/10

(52) U.S. Cl. 40/124.09

(57) ABSTRACT

Disclosed is a greeting card arrangement including a greeting card fixed in place within a display frame and a greeting card display frame for separate or interchangeable greeting cards.

In one embodiment the greeting card display frame is formed from a single sheet (20 FIG. 11) which is folded along lines 21a, b and c. Sections 1 and 4 are folded inwardly and sections 2 and 3 are then folded inwardly together, such that section 3 forms a front frame, section 4 is viewable from the aperture 23 in section 3, section 1 forms a card holder and section 2 includes various rear stand formations or hangers.

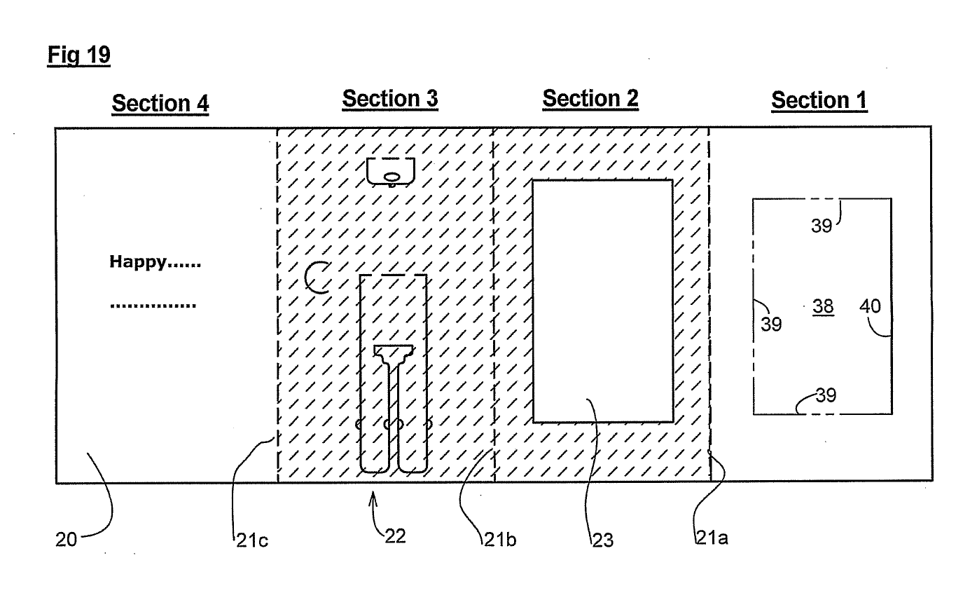

In another embodiment (FIG. 19) the card 27 shown in FIG. 11 can be omitted, such that the message on section 4 in FIG. 19 is viewable behind a flap 38 in section 1.

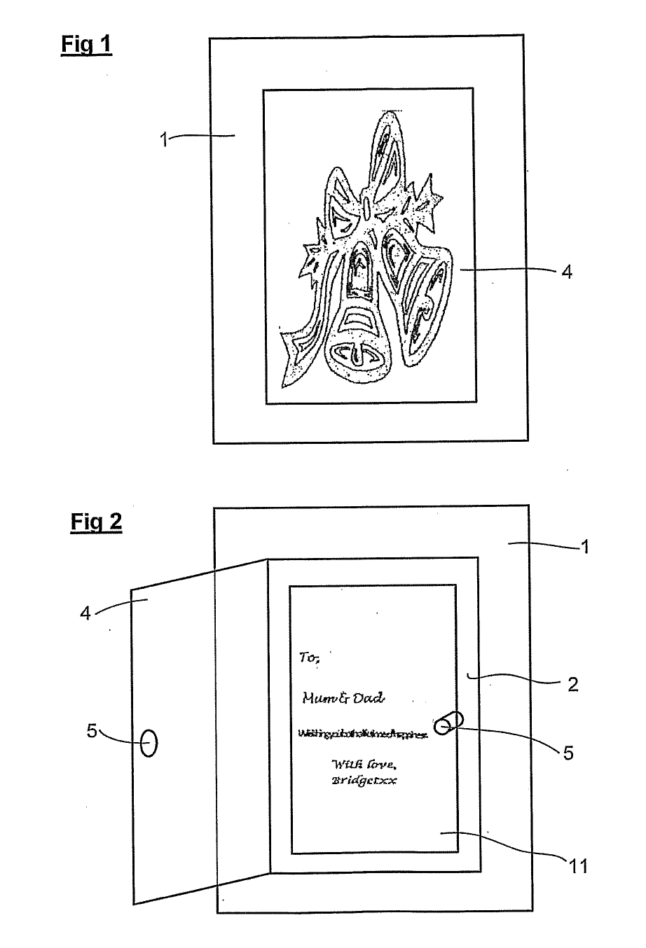

In yet another embodiment shown in FIGS. 1 to 10 the card and frame need not be formed from one sheet but may be separate sheets fixable together.

The invention relates to a greeting card arrangement including a greeting card fixed in place within a display frame and a greeting card display frame for separate or interchangeable greeting cards.

Greeting cards are highly priced especially in relation to their short lifespan. They are often discarded or put away to be long. forgotten along with the treasured memories, and sender details. They also tend to fall over or sit awkwardly when displayed due to their tendency to warp, resulting in ineffective display and unappealing appearance.

The only visible part of a conventional greeting card is the front image, but whilst the front image may be being aesthetically pleasing, it does not allow easy access for viewing the inner message/verse/quote or sender details, which is often the most important part of sending and receiving a greeting card.

To address these problems, the inventor proposes a greeting card arrangement as claimed having optional features defined by dependent claims.

In one variation, there is a card arrangement which has a greeting card fixed within a display frame (the fixed greeting card) and in another variation, a greeting card display frame is used for removeably holding a card such that the frame can display interchangeable greeting cards.

Both variations allow the greeting cards to become cost effective keepsake items. They have concealed magnetic fasteners to allow opening and closing of the card neatly, firmly and securely within the display frame, allowing easy access for viewing the inner message/verse/quote/sender details.

The display frame holds the greeting card neatly within the frames allowing the card to retain its shape and appearance.

A display stand may be attached to a back support and may have fasteners fixed to its inner side and to the back support that connect together firmly to allow optional and neat display for hanging the fixed greeting card within a display frame/greeting card display frame.

The fixed greeting card display frame and greeting card display allow greeting cards to become keepsake items therefore ensuring the invention is a cost effective product.

Both variations may have concealed magnetic fasteners to open and close the card neatly, firmly and securely within the display frame invention, ensuring easy viewing of the inner message/verse/quote and secure firm closing for the display of the front image of a greeting card.

The display frame holds the greeting card within the frame ensuring that the card retains its shape and appearance whilst ensuring effective displaying. The display stand attached to the back support, may be manufactured from sturdy materials, and may have fasteners, preferably hoop and loop fasteners. Although, other types of fasteners may be used, and are fixed to the inner side of the stand and to the back of the back support, ensuring firm temporary attachment for the display stand to sit flat against the back support for optional hanging of the frame.

A hanging means may be provided, preferably attached by holes, and eyelets may be provided, made from a variety of materials such as wire/cord/ribbon.

The greeting card display frame can be made with a variety of materials, for example, heavyweight paperstock and card/woods/plastic/leather/metal. For keeping costs at its lowest, it would be preferably made from heavyweight papers/card and allowing for postage as conventional greeting cards.

By way of example of the invention will now be described with reference to the accompanying drawings, note that the image, words/greeting on the sample greeting cards are for illustrative purposes only and other indicia could be present or blank cards could be used.

FIGS. 1 to 10 show two embodiments (variations) of the invention in which are shown features of a greeting card fixed or fixable in place in a display frame, and features of a display frame into which a greeting card is either fixed or removeably insertable.

FIG. 1 shows the front perspective view for both variations of the front image part of a greeting card within the display frame.

FIG. 2 shows a front perspective view for both variations of the invention, of the inside part of a greeting card framed within the smaller inner aperture when a greeting card is opened. The inner front of the greeting card shows a magnet fastener attached to the middle opening edge. The attracting magnet fastener on the inner back of the display support is although shown for illustration of placement is concealed behind the back part of the greeting card.

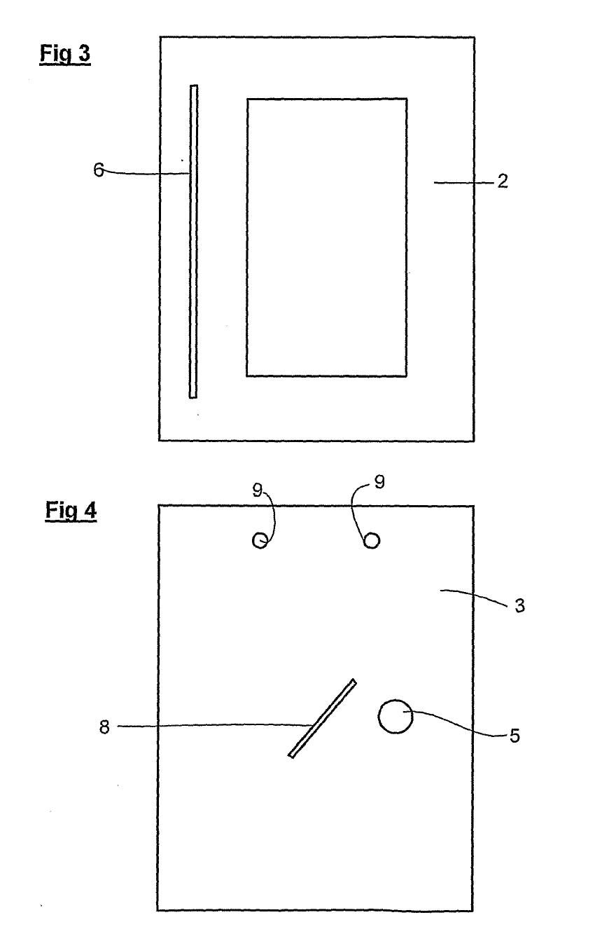

FIG. 3 shows a front perspective view for the fixed greeting card within a display frame of the inner frame with slot to the left of the frame. The front perspective view for the fixed greeting card would be as the same apart from a smaller slot width and length.

FIG. 4 shows the inner of the back display for the fixed greeting card within a display frame. Of which a magnet fastener is attached to middle right of the inner back support. A slat for stand, and holes and eyelets.

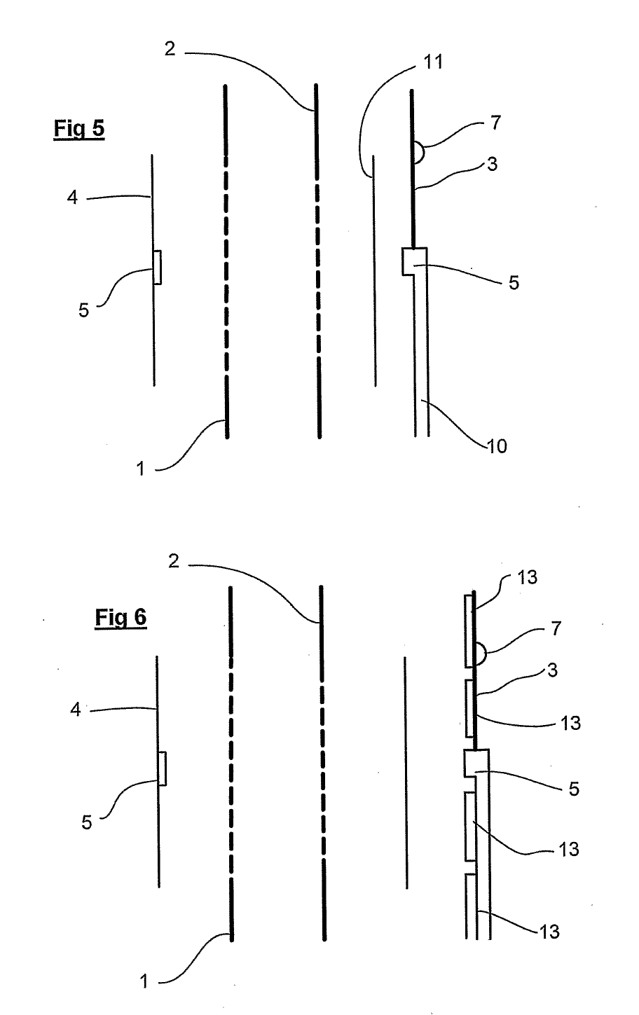

FIG. 5 shows the side view of the structure of the fixed greeting card within a display frame, with a magnet fastener attached to the inside front part of the greeting card, outer frame and aperture, inner frame with smaller aperture, back part of the greeting card, inner back support with magnet fastener attached and the back support with a closed stand and hanging feature.

FIG. 6 shows a side view of the structure for the greeting card display frame. The front of a sample greeting card with magnet fastener attached to the inside. The outer frame and aperture, inner frame and smaller aperture, back part of a sample greeting card, inner back support with magnet fastener and spacing material. The back support is shown with a closed stand and hanging feature.

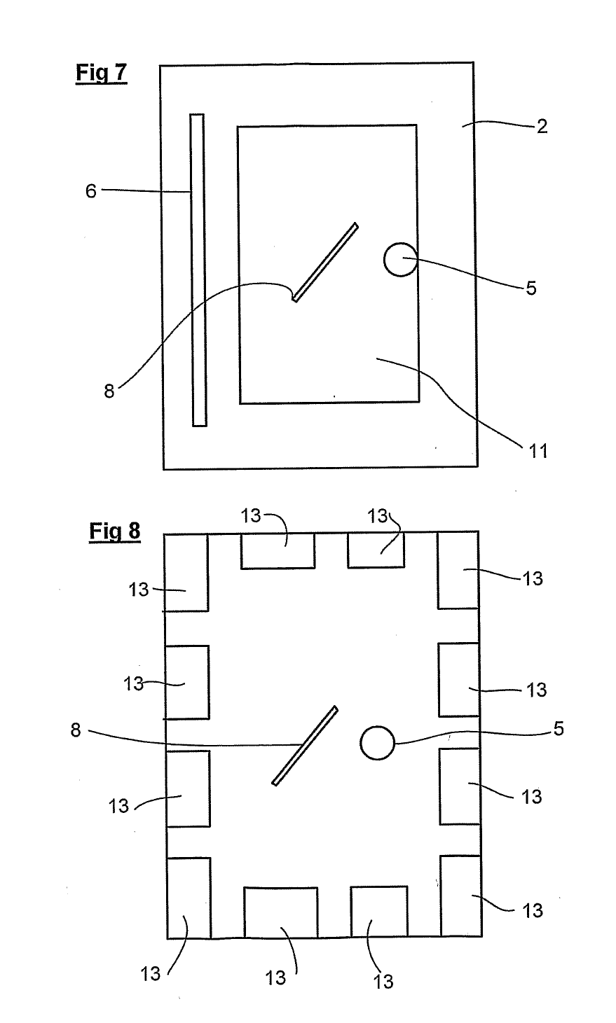

FIG. 7 shows for both variations a front view of the inner back support showing through the smaller inner aperture with magnet fastener and slat for stand and inner frame with slot to the left side of the inner frame.

FIG. 8 shows a front view for the greeting card display frame, of the inner back support with spacing material attached, magnet fastener and slat for stand.

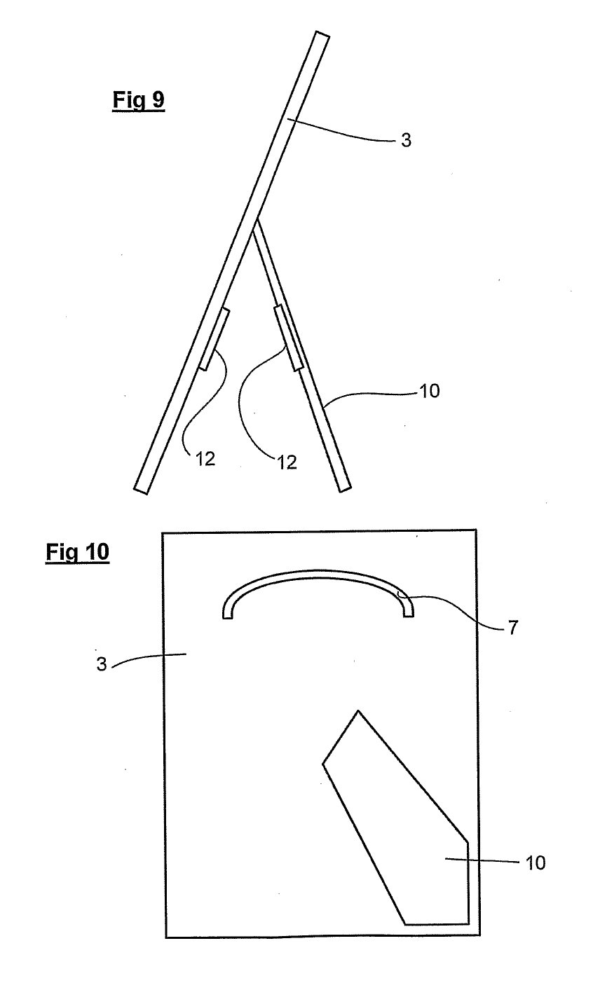

FIG. 9 shows the side view of the constructed frame for both variations, with stand open, fastener to the inner of the stand and back support, hanging feature and edging material to the outside edges of the frame.

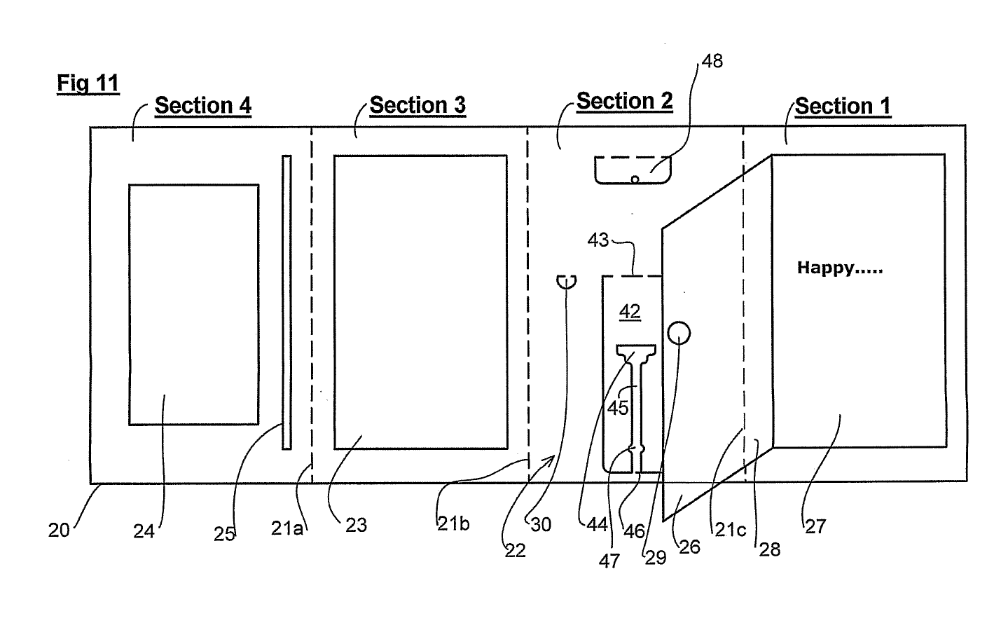

FIG. 10 shows the back support for both variations with closed stand and optional hanging feature.

Both variations of the invention are made up of an outer frame with aperture 1, an inner frame with smaller aperture 2, slot 6, back support 3 with optional stand 10 and hanging feature 7. The slot 6 on the inner frame 2 for a portrait style is to the left of the inner frame for portrait style, and would be to the top of the inner frame for landscape style.

Other parts that make up both variations of the invention shown in FIGS. 1 to 10 include two attracting magnet fasteners 5, one attached to the inner back support 3, towards the middle right for a portrait style as shown, and would need to be placed to the middle bottom for a landscape style.

An attracting magnet fastener is attached to the inner front opening edge of a greeting card 4 to the middle. Self-adhesive attracting magnet fasteners 5 are supplied with the product for self attachment to the inner front part of greeting cards 4, if required.

For both variations; the stand preferably has hook and loop fasteners 12 for fixture to the inner of the stand 10 and to the back support 3. Preferable methods and materials for hanging feature are holes and eyelets 9, although other suitable materials and methods of fixing may be used in place of the hook and loop, holes and eyelets.

For the greeting card display frame, for separate insertion of greeting cards, spacing material 13 is attached to the inner back support 3 to allow clearance space for self insertion of greeting cards.

For the construction of the fixed greeting card within a display frame; a magnet fastener 5 approx 10 mm diameter×1 mm depth is attached towards the middle right of the inner back support 3 for portrait style. It is suggested that a slat 8 is made for insertion of the top end of the stand 10 and is adhered/fixed firmly to the inner back support 3 and the hanging feature 7 and holes and eyelets 9 are put in place to the back support 3.

The front part of the selected greeting card 4 is inserted through the back of the slot 6 of the inner frame 2. The slot width is approximately 2 mm and the length exceeding the inner aperture at each end by approximately 2 mm. The slot width and length will be varied for the different sizes of the fixed greeting card within a display frame. The back of the greeting card 11 is adhered firmly to the inner back support 3 over and concealing the magnet fastener 5 and stand slat 8. The smaller inner frame 2 is placed over the inner back part of the greeting card 11 and adhered to the inner back support 3 to allow the message/verse/quote/sender details to be framed for display within the smaller inner aperture 2. It is suggested that the outer frame 1 is then adhered onto the front of the inner frame 2 and onto the inner back support 3, allowing the front image part of the selected greeting card 4 to sit within the outer frame 1 aperture. The attracting magnet fastener 5 is attached to the inner middle opening edge of the front part of the greeting card 4 and aligned with the magnet fastener 5 concealed on the back support 3. Edging material 14 be adhered to the constructed display frame outer edges if required.

For construction of the greeting card display frame; the inner back support 3 has a magnet fastener 5 for attachment to inner back support middle right for portrait style, slat 8 for stand and as for the fixed greeting card within a display frame. Spacing materials 13 are adhered around all edges of the inner back support 3. The slot 6 on the inner frame 2 has a width approximately 2-3 mm and a length that exceeds the inner aperture by approximately 1 cm at each end. There is approximately a 1 cm gap on each of the four edges of the inner aperture frame 2 that are left unadhered, to allow for the edges of the back of the card 11 to sit behind the inner aperture frame edges. The slot width, length and the unadhered inner aperture frame edges will be varied for the different sizes of the greeting card display frames. The remaining part of the inner frame 2 is then adhered firmly onto the spacing material 13 that is adhered to the inner back support 3. The outer frame 1 is adhered to the inner frame 2 that is adhered to the spacing materials 13 at the inner back support 3. Edging material 14 be fixed to all edges of the constructed display frame to conceal the spacing materials 13. Attracting magnet fasteners are supplied with the greeting card display along with alignment instructions for self insertion of a greeting card.

For the fixed greeting card within a display frame and greeting card display, materials used for both outer frame, inner frame and back support are heavy weight paper/card, although other materials such as wood/plastic/leather/metal may be used. The outer frame may be covered with textiles/adornment features for additional decoration. The stand is made of heavyweight sturdy material to allow for effective standing display. The hanging feature may be made from a variety of materials, such as wire, cord, ribbon. Other variations and modifications will be apparent to the skilled addressee.

In summary, the embodiments described above show a fixed greeting card, i.e. one which is fixed in place within a frame, within a display frame and a greeting card display frame comprising:

an outer frame (1) with aperture fixed to an inner frame (2) with a smaller aperture, that is secured to a back support (3), to which a magnetic fastener (5) is adhered to the inner back support and connects to an attracting magnet fastener that is aligned to the opening side of the inner front of a greeting card, allowing a greeting card to be opened at the outer aperture within the constructed display frame, for the viewing of the message/greeting/verse/quote/sender that is enclosed within its own inner frame, and then closes securely and neatly for displaying the front image of a greeting card.

They show also a fixed greeting card within a display frame and greeting card display frame in which the inner frame has a slot either to the left or top the inner frame depending upon portrait or landscape style, for insertion of the greeting card part.

They show also a greeting card display frame in which spacing materials are adhered around all four outer edges of the inside back support, allowing clearance space for the front insertion of the back part of a greeting card.

They show also a fixed greeting card within a display frame and greeting card display frame of which a stand is attached to the back support with a fastener attached to the inner of the stand, aligned with a fastener to the back support, allowing the two parts to connect for secure closure for optional hanging, and that the fasteners are made of suitable materials, preferably hook and loop.

They show also a greeting card display frame in which the inner frame apart from the inner aperture edges and slot, is fixed to onto the spacing material, the outer frame adhered to the inner frame, the back part of a greeting card is self inserted through the front of the slot on the inner frame and slides behind the inner aperture with the edges of the greeting card secured and sitting behind the inner aperture edges, concealing the magnet fastener on the inner back support, attracting magnet fasteners are supplied for self alignment to the inner of the front part of a greeting card.

They show also a fixed greeting card within a display frame of which the front perspective view of inner frame has a slot to the left for a portrait style card or above the inner aperture for a landscape style card, the front part of the selected greeting card is inserted through the slot from behind the inner frame.

They show also a fixed greeting card within a display frame in which the back part of a selected greeting card is adhered to the inner back support over the magnet fastener, the front part of the selected greeting card is inserted into the slot from behind the inner frame, allowing the back part of the greeting card edges to sit behind the inner aperture edges, the inner frame fixed to the inner back support and the outer frame fixed to the inner frame, an attracting magnet fastener is adhered to the inner front part of the selected greeting card at the middle opening edge, in line with the attracting magnet fastener on the back support which is concealed by the back part of the greeting card.

They show also a fixed greeting card within a display frame in that the permanent fixture of a selected greeting card includes all occasions, adversity, motivational, inspirational, photocards, designs, artwork, handcrafted, inner blank for own messages, and themed cards.

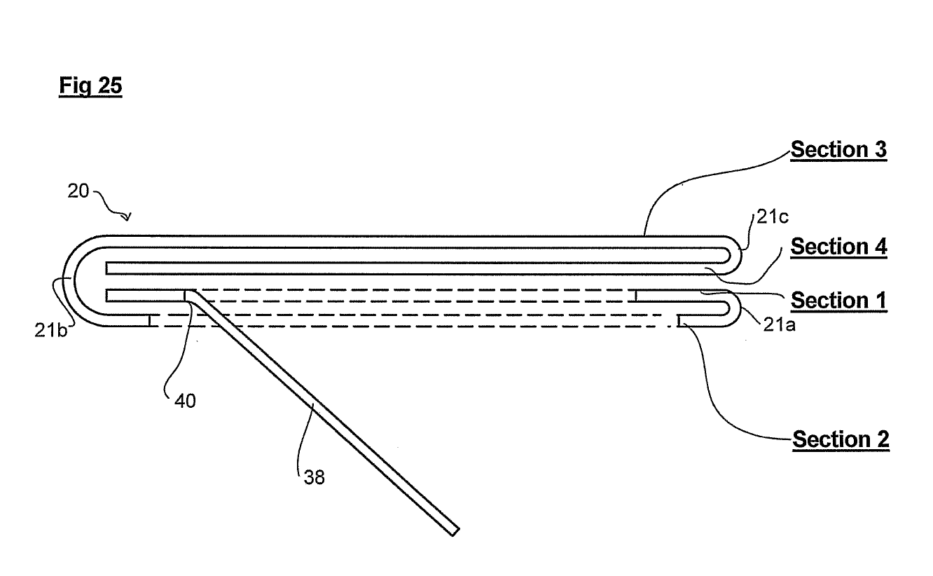

FIGS. 11 to 25 show a further two embodiments of the invention, which have similar features to the embodiments described above.

Referring to FIGS. 11 to 18, a framed greeting card arrangement is shown. In FIG. 11 the frame is shown unfolded formed from a single sheet 20 of card material. The sheet 20 is folded in use at fold lines 21a, 21b and 21c. The sheet includes four sections, section 1, section 2, section 3 and section 4. Section 1 is plain, section 2 has die-cut formations 22, which can be the same or similar to those described above. Alternatively, as illustrated, the die cut formations include a stand 42 which can pivot outwardly along hinge 43. The stand is prevented from pivoting too far by a retaining strap 45, itself hingeable at a hinge area 46 and having an enlarged end portion 44 engageable with the stand 42 at an area 47 at which both the stand 42 and strap 45 intersect when they are pivoted away from the remaining portions of section 2. A hanger 48 is provided also for hanging the arrangement on a hook and includes a pivoted tab having a hole punched in it.

Section 3 includes a front or outer display aperture 23 and section 4 includes an inner display aperture 24 and a slot 25. After the formations 22, apertures 23 and 24 and slot 25 have been die-cut, a conventional single leaf folded page greeting card 26 is secured by means of adhesive to the plain section 1 of the sheet 20. The rear section 27 only of the card is secured to the plain section 1, leaving the front section 28 of the card forming a flap which is hinged on one side so that it is openable and closeable.

As will be explained in more detail below the flap 28 is held in a closed position by means of a magnet 29 which cooperates with a further magnetic element 30 held to the section 2, when the frame is folded.

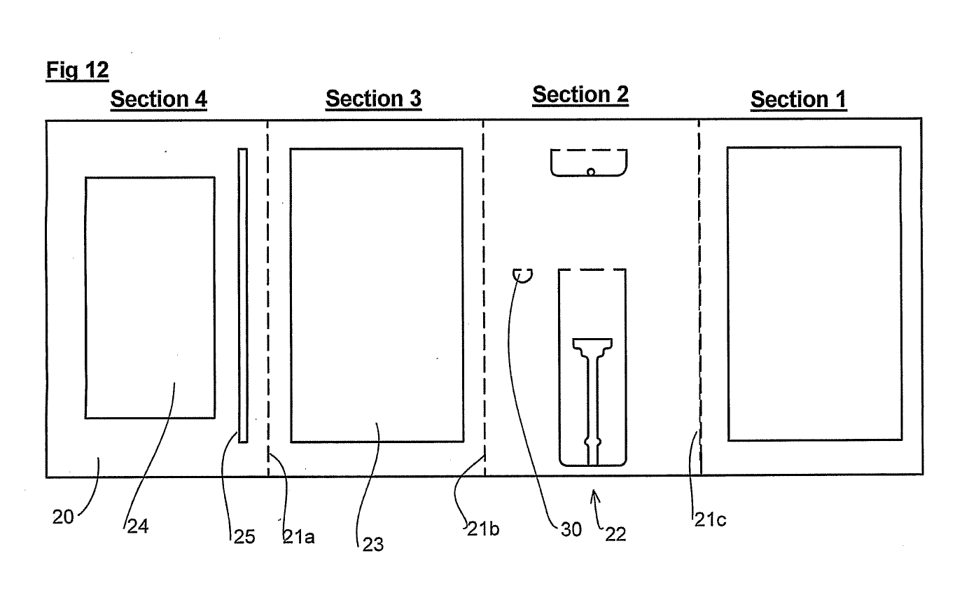

FIG. 12 shows the same view as FIG. 11, except that the card 26 has been removed. This Figure illustrates that the fixing of the card 26 to the plain section 1 prior to folding is optional, because the card 26 can be inserted after folding if required and so interchangeable cards can be used.

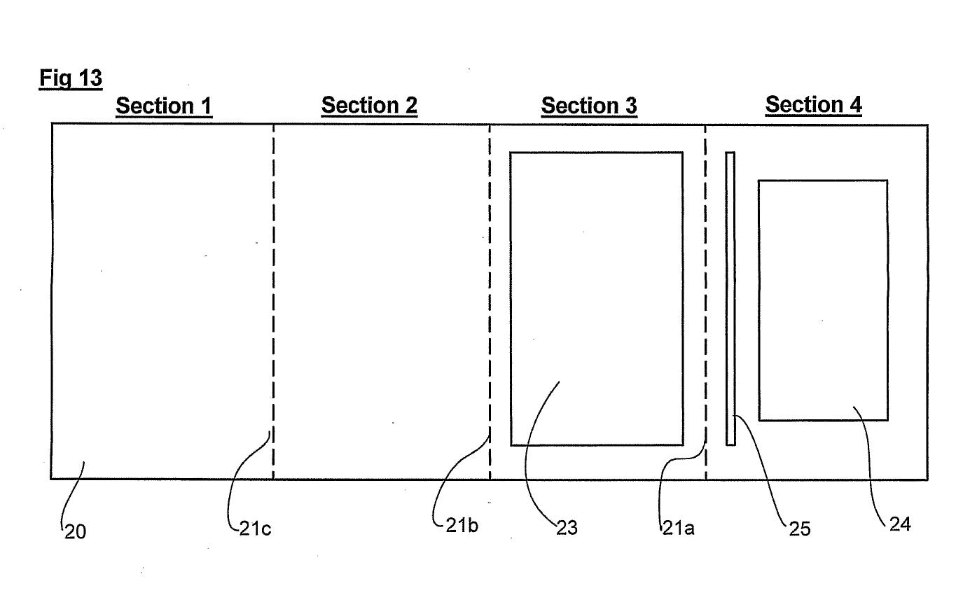

FIG. 13 shows the opposite face of the sheet 20 shown in FIGS. 11 and 12.

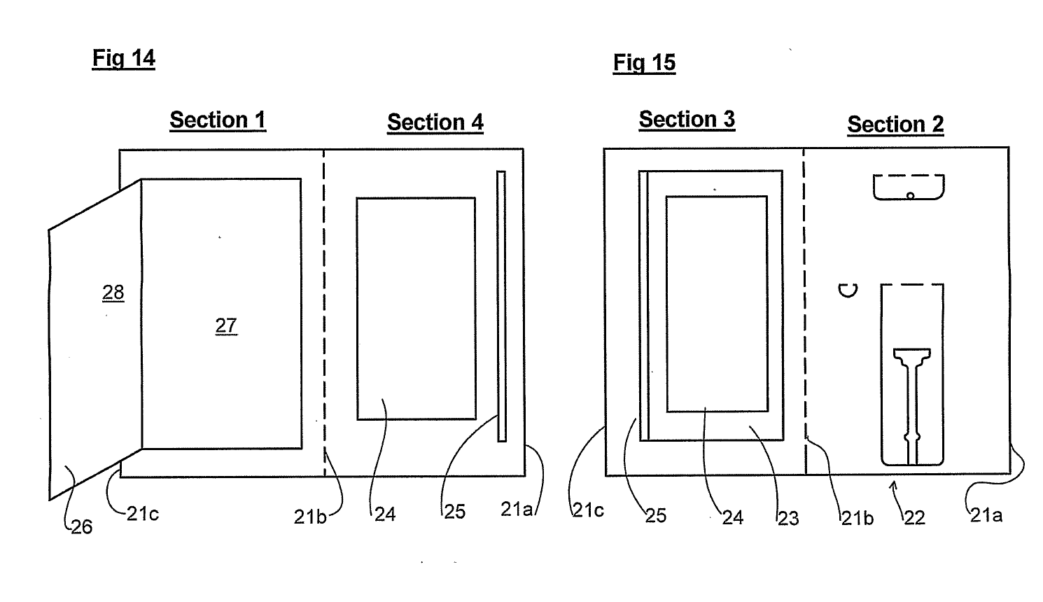

With reference to FIG. 14 the sheet 20, shown in FIG. 11 (with greeting card 26 attached) can be folded along the two outer fold lines 21a and 21c such that sections 1 and 4 are folded away from the view shown i.e. in the direction into the paper and underneath sections 2 and 3 respectively. The result of this folding will be a partially manufactured framed card as shown in FIG. 14. FIG. 15 shows the opposite side of the frame shown in FIG. 14.

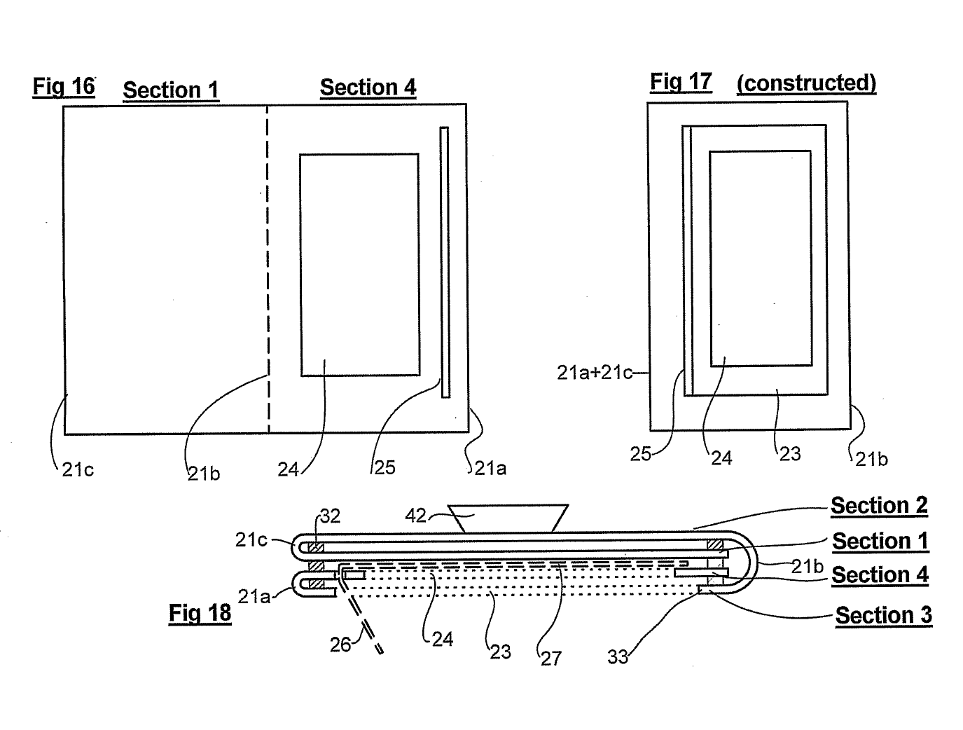

The final manufacturing step is to fold the frame further along the central fold line 21b ensuring that the flap 28 is inserted through the slot 25 (where a card 26 is used initially). The resultant arrangement is shown in FIG. 18, wherein a multi-layered greeting card arrangement is illustrated. Section 3 becomes a front layer having a display aperture 23 which exposes the underlying aperture 24 and forms a frame therearound. Section 4 becomes a middle layer and aperture 24 is used to display a message, or other indicia on the rear section 27 of the greeting card 26. Section 2 becomes a backing layer which provides support for the stand or hanging means 22 and section 1 becomes a stiffening layer, adding strength to the stand. A display layer, on which the card's indicia will be formed, is, in this case formed by the card rear section 27. The construction is held together generally by adhesive 32, although other fixing or securing methods can be adopted, for example double-sided adhesive tape, thermal welding, mechanical fastenings such as staples or similar means.

Where a greeting card 26 is not assembled with the frame, then the frame construction is identical, and is illustrated in FIGS. 16 and 17. However, since a greeting card similar to greeting card 26 will need to be inserted after assembly of the frame then a space is left between sections 1 and 4 when they are brought together. In that instance, spacers or the like can be used similar to the spacers 13 described above.

FIGS. 19 to 25 illustrate yet another embodiment of the invention.

In this variant the card 26 described above is not used. Instead, a flap 38 is formed by die-cutting three sides 39 of a rectangle and leaving one side of the rectangle to form a hinge 40 so that the flap is openable and closeable. Additionally a message or other indicia is formed on the otherwise plain section 4. Other than these variations, the framed greeting card is as described with reference to FIGS. 11 to 18, and like parts have like reference numerals.

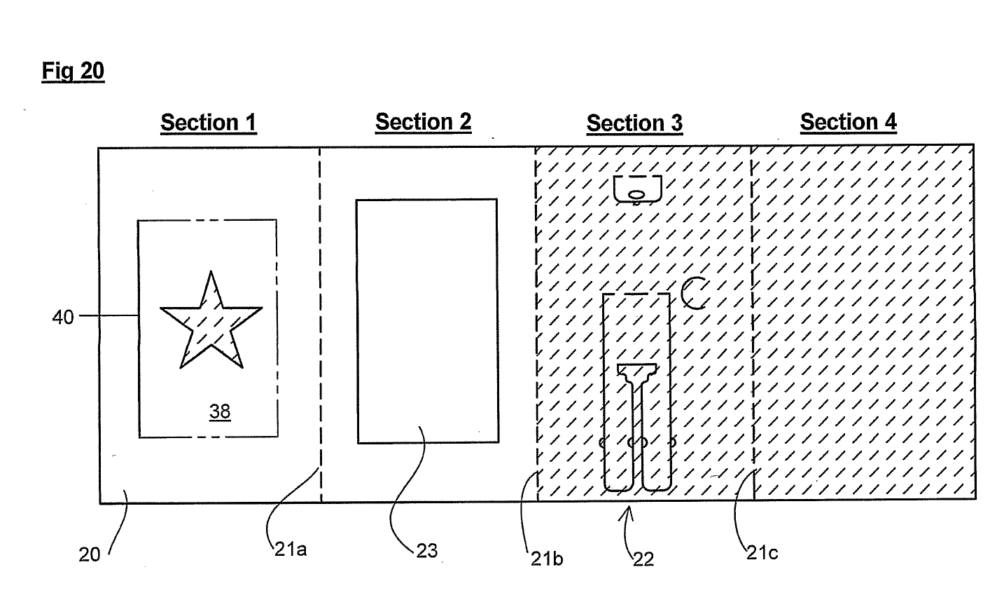

FIG. 20 shows a view of the opposite face of the sheet 20. With reference to FIG. 20, during assembly sections 1 and 4 are folded along lines 21a and 21c respectively upwards out of the paper and their respective edges are brought toward the fold line 21b.

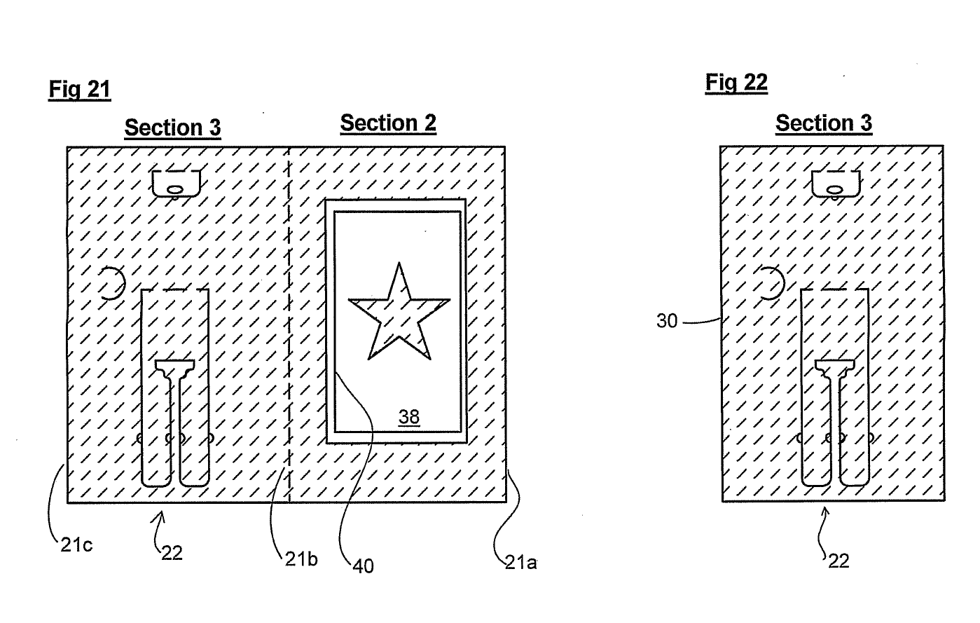

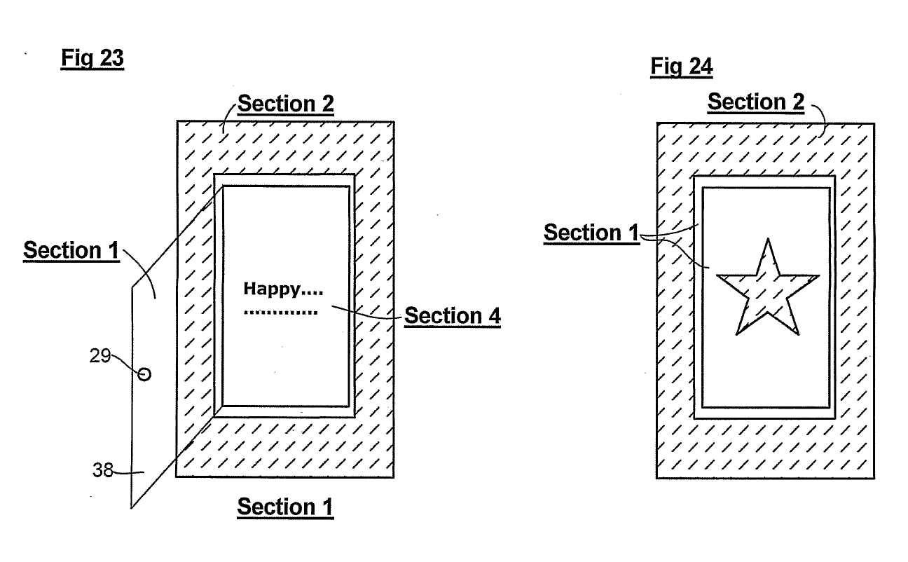

The resultant partially formed framed greeting card is shown in FIG. 21. When the card shown in FIG. 21 is folded again along fold line 21b into the paper such that fold lines 21a and 21c are brought together the resultant construction is shown in FIGS. 22 to 25. It should be noted that this variant includes a magnetic pair 29 and 30 shown in FIGS. 22 and 23 for maintaining the flap 38 in a closed position in use. The flap 38 shown in FIG. 23 is illustrated as if it were transparent, for clarity, although in practice it is more likely that the flap will be formed from the same card material as the sheet 20.

FIG. 25 shows a section through the finished frame and card. From this drawing it is apparent that section 2 forms a front layer, section 1 forms a middle layer, which includes flap 38 and section 3 forms a backing layer. Section 4 is a display layer on which indicia can be formed, but it can be seen that section 4 is not essential, if the card message or indicia is formed on the front face of the backing layer (section 3). However, the inclusion of section 4 provides a stiffening effect, thus forming a stiffening layer. One advantage of the framed card arrangement shown in FIG. 25 is that it is formed from a single sheet of material (card) or the like and so this arrangement is particularly advantageous for mechanised construction.

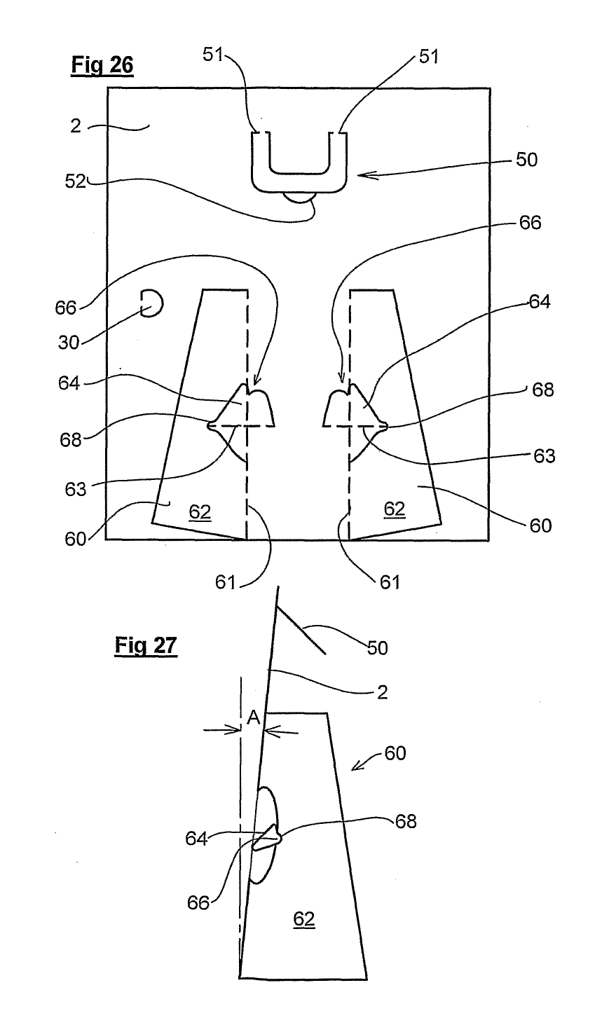

FIG. 26 shows an alternative to the hanger arrangement 7 and 48, and an alternative the stand arrangement 10 and 42 described above. In this alternative, a hanger 50 is die cut from a rear section, for example section 2 as described above, so that it can be folded outwardly, in a direction out of the paper in the drawing, to form a U shaped protrusion having a two fold lines 51, at which the hanger is joined to the remaining rear section 2. A small aperture 52 cut from the rear section 2 allows a user to hinge the hanger 50 away from the rear section 2, for hanging the card on a wall or the like.

Also shown in FIG. 26 is a pair of stands 60 which can be used alone or together, to support the card on a flat surface such as a table or desk. Each stand 60 has a buttress 62, die cut from the rear section 2. The buttress 62 can be folded outwardly along vertical fold line 61. The stand 60 includes also a holding part 64, which too is die cut and can be folded outwardly along a horizontal fold line 63, which is perpendicular to the fold line 61. The holding part is folded in use so that a detent 66 in the holding part 64 is forced into a recess 68 in the already outwardly folded buttress 62.

FIG. 27 shows the assembled stand 60 and the hanger 50 partially unfolded. In use, one or other of the arrangements 50 or 60 may be used, rather than both. The use of two stands 60 allows extra stability. Flap 30 is used, as described above for insertion of and concealing a magnet. The card is inclined form the vertical by an angle A which ideally is about 5° to 10° when supported by stands 60.

It will be apparent to the skilled addressee that various modifications and variants are possible within the scope of the invention claimed. In particular the materials described could be replaced by other sheet materials, for example plastics with equal effect. The greetings cards and frames illustrated need not be rectangular, or square. Although these parallelepiped shapes are preferred, other shapes could be employed. In particular the apertures illustrated could be round, oval or an irregular shape for example. The term greeting(s) card should be interpreted broadly to include the types of card mentioned herein, as well as cards that display any type of messages or indicia, like calendars, e.g. 12 interchangeable cards can be used, for inserting into a frame, one for each month of the year. Blank cards could also be used.

1. A greeting card arrangement formed from multiple layers of sheet material including: a backing layer; a middle layer; and a front layer; all held together to form a card frame; the middle layer having a first display aperture for displaying a card message or other indicia; and the front layer having a second display aperture larger than the first aperture for exposing the first aperture and to form a frame around the first aperture; characterised in that the arrangement includes an openable and closeable flap hinged along one side, openable to view said card message or other indicia.

2. A greeting card arrangement as claimed in claim 1 further including: a display layer between the backing and middle layers viewable through the first aperture having said message or indicia formed thereon.

3. A greeting card arrangement as claimed in claim 1 wherein, the middle layer includes a slot through which is inserted or insertable a folded page in use, said folded page having a rear section for forming said display layer and a front section for forming said flap.

4. A greeting card arrangement as claimed in claim 3 wherein the second aperture is in the form of a parallelepiped.

5. A greeting card arrangement as claimed in claim 4, wherein the slot extends along substantially the whole length and adjacent to one edge of the parallelepiped aperture so that the front section of the folded page is substantially closeable into the second aperture, is framed by the front layer and is openable to reveal its rear section through the first aperture.

6. A greeting card arrangement as claimed in claim 3, wherein there the backing and middle layers are held together in spaced relation by one or more spacers so that the page is removeably insertable into said space.

7. A greeting card arrangement as claimed in claim 3 wherein the page is secured between the backing layer and the middle layer.

8. A greeting card arrangement as claimed in claim 2 wherein the flap is formed from the middle layer and when opened forms the first aperture.

9. A greeting card arrangement as claimed in claim 1, wherein the backing layer includes one or more magnetic or magnetisable elements for cooperation with a complementary magnetic or magnetisable element disposable on the back face of the flap.

10. A greeting card arrangement as claimed in claim 1, wherein the backing layer includes a support stand for standing the frame on a surface and/or means for hanging the frame.

11. A greeting card arrangement as claimed in claim 10 wherein the support stand comprises at least one die cut stand member cut from the backing layer and foldable outwardly away from the backing layer and at least one further die cut piece foldable away form the backing layer for engaging with the or each outwardly folded stand member to hold the stand member in its folded position.

12. A greeting card arrangement as claimed in claim 11 wherein the or each stand member is outwardly foldable generally vertically in use, and the or each further die cut piece is outwardly foldable in use generally horizontally.

13. A greeting card arrangement as claimed in claim 1 wherein two or more of said layers are formed from a single sheet of material folded to form two or more of said multiple layers.

14. A greeting card arrangement as claimed in claim 13 wherein the backing, middle and front layers are a single sheet of material folded to form said multiple layers.

15. A greeting card arrangement as claimed in claim 1, further including a stiffening layer disposed in use between the backing and middle layers.

16. A greeting card arrangement as claimed in claim 15, wherein the backing, stiffening, middle and front layers are formed from a single sheet of material.

17. A greeting card arrangement as claimed in claim 15, wherein the flap is cut from the middle layer and said message or other indicia are formed on the stiffening layer.

18. (canceled)
